(19) United States
(12) Patent Application Publication
(10) Pub. No.: US 2016/0198286 A1
(43) Pub. Date: Jul. 7, 2016

(54) SENSOR INSTALLATION LOCATION DETERMINATION SUPPORT SYSTEM AND SENSOR INSTALLATION LOCATION DETERMINATION SUPPORT METHOD

(71) Applicant: Murata Manufacturing Co., Ltd., Kyoto (JP)

(72) Inventors: Ryuhei NAKAI, Kyoto (JP); Takayuki HORIBE, Kyoto (JP); Takeshi SATO, Kyoto (JP); Suguya IBARAKI, Kyoto (JP)

(21) Appl. No.: 15/070,751

(22) Filed: Mar. 15, 2016

Related U.S. Application Data
(63) Continuation of application No. PCT/JP2014/065961, filed on Jun. 17, 2014.

(30) Foreign Application Priority Data
Sep. 17, 2013 (JP) 2013-191308

(51) Int. Cl. H04W 4/00; H04M 3/42; H04L 29/08; H04W 4/02

(52) U.S. Cl. CPC H04W 4/006; H04W 4/02; H04M 3/42; H04W 4/001; H04L 67/18

(57) ABSTRACT

Provide a sensor installation location determination support system and a sensor installation location determination support method that ensure accurate determination of sensor location information even in a case where a sensor to be installed is not equipped with GPS functionality. A sensor installation location determination support system includes a sensor detecting characteristic information of target object, a portable terminal communicatively coupled with the sensor for data communication, and a server collecting information.

### BACKGROUND

### Technical Field

The present disclosure relates to a sensor installation location determination support system and a sensor installation location determination support method that support efficient determination of installation locations for various sensors.

A number of sensor network systems are being developed. The sensor network systems collect information detected by a plurality of sensors and provide useful functionalities for various applications. The various sensors are each provided with a sensor function and a communication function. Detected sensor information is gathered, for example, at a server by using wireless communication, and a variety of information processing is carried out therein.

Patent Document 1 discloses a sensor network in which each wireless sensor node includes its own location determination means for determining location (for example, a global positioning system (GPS) location detector device including a GPS antenna), and in which sensor information and location information detected by sensors are transmitted to a surveillance server. In Patent Document 1, the surveillance server collects the location information of all the sensors and generates a map indicating relative locations of the wireless sensor nodes.

Patent Document 1: Japanese Unexamined Patent Application Publication No. 2005-328230

### BRIEF SUMMARY

In the sensor network disclosed in Patent Document 1, however, each and every wireless sensor node is needed to have the GPS location detection device with a GPS antenna, which is relatively expensive. Thus, despite a smaller size and lower cost of the sensor itself, there is an issue in that downsizing and cost reduction are difficult to achieve because of addition of the GPS functionality. It is not noticeable when the number of the sensor nodes is small. However, as the number of the sensor nodes grows, an increase in cost due to the addition of the GPS functionality becomes too large to ignore.

On the other hand, the detection range of a sensor is easily affected by surrounding circumstances of the sensor's installation location. Thus, it is needed to determine the sensor's installation location while checking the state of detection. To understand the sensor's installation location, there is a desire for an accurate, inexpensive own-location determination means.

The present disclosure is made in view of the foregoing matters, and the present disclosure provides a sensor installation location determination support system and a sensor installation location determination support method that provide accurate determination of sensor location information even in a case where a sensor to be installed does not include the GPS functionality.

A sensor installation location determination support system according to the present disclosure includes a sensor detecting characteristic information of target object, a portable terminal communicatively coupled with the sensor for data communication, and a server collecting information, wherein the portable terminal includes a location information acquisition means for obtaining location information regarding own location, and a location information transmitter means for transmitting the location information obtained to the server while making a connection with identification information identifying the sensor, and wherein the server includes a location information receiver means for receiving the location information and the identification information from the portable terminal, a determination means for determining whether an installation location of the sensor is appropriate or not based on the location information received, and a result transmitter means for transmitting a determination result obtained from the determination means to the portable terminal.

In the foregoing configuration, the portable terminal obtains the location information regarding own location, and transmits the location information obtained to the server while making a connection with the identification information identifying the sensor. The server receives the location information and the identification information from the portable terminal, determines whether the installation location of the sensor is appropriate or not based on the location information received, and transmits the determination result obtained to the portable terminal. This ensures, at the server, collecting of the location information of the installation locations of the sensors even if the sensor itself does not include a means for obtaining location information such as, for example, an expensive GPS chip and the like. Furthermore, the foregoing configuration allows the portable terminal to be used for checking the determination result as to whether the installation location of the sensor to be newly installed is appropriate or not depending on the relative spatial relationship between the sensors. This enables the installation location of the sensor to be changed to more appropriate location while checking the determination result, and installation work to be supported so as to install the sensor at a most appropriate location.

In the sensor installation location determination support system according to the present disclosure, the location information acquisition means can obtain longitude information and latitude information as the location information by using GPS.

In the foregoing configuration, the portable terminal obtains the longitude information and the latitude information as the location information by using GPS. Thus, there is no need to have an expensive GPS chip in the sensor itself to obtain the location information, and the number of installing sensors, however large, does not contribute to an increase in cost of the system as a whole.

In the sensor installation location determination support system according to the present disclosure, the location information transmitter means can obtain the identification information of the sensor via the data communication with the sensor using contactless close-range communication.

In the foregoing configuration, the portable terminal communicates with the sensor to obtain the identification information of the sensor via the data communication with the sensor using contactless close-range communication. This enables the server to easily determine which sensor the location information corresponds to. Thus, whether the installation location of a sensor to be newly installed is appropriate or not can be determined by comparing location information of a sensor that is already installed and location information of the sensor to be newly installed.

In the sensor installation location determination support system according to the present disclosure, the server can store information regarding a detectable range of each sensor, and the determination means determines, based on the location information received, whether the installation location is appropriate or not by comparing the location information of a sensor that is already installed and the location information of a sensor to be newly installed.

In the foregoing configuration, whether the installation location is appropriate or not is determined by comparing the location information of a sensor that is already installed and the location information of a sensor to be newly installed based on the location information indicating the installation location of the sensors. Thus, void space between the sensing areas where sensor detection is not possible may be minimized, and at the same time the number of installing sensors may be limited to the minimum.

Next, a sensor installation location determination support method according to the present disclosure is a method that can be implemented in a sensor installation location determination support system including a sensor detecting characteristic information of target object, a portable terminal communicatively coupled with the sensor for data communication, and a server collecting information, wherein the portable terminal includes a step for obtaining location information regarding own location, and a step for transmitting the location information obtained to the server while making a connection with identification information identifying the sensor, and wherein the server includes a step for receiving the location information and the identification information from the portable terminal, a step for determining whether an installation location of the sensor is appropriate or not based on the location information received, and a step for transmitting a determination result to the portable terminal.

In the foregoing configuration, the portable terminal obtains location information regarding own location, and transmits the location information obtained to the server while making a connection with identification information identifying the sensor. The server receives the location information and the identification information from the portable terminal, determines whether an installation location of the sensor is appropriate or not based on the location information received, and transmits a determination result obtained to the portable terminal. This ensures, at the server, collecting of the location information of the installation locations of the sensor even if the sensor itself does not include a means for obtaining location information such as, for example, an expensive GPS chip and the like. Furthermore, the foregoing configuration allows the portable terminal to be used for checking the determination result as to whether the installation location of the sensor to be newly installed is appropriate or not depending on the relative spatial relationship between the sensors. This enables to change the installation location of the sensor to more appropriate location while checking the determination result, and to support installation work so as to install the sensor at a most appropriate location.

The sensor installation location determination support method according to the present disclosure can obtain longitude information and latitude information as the location information by using GPS.

In the foregoing configuration, the portable terminal obtains the longitude information and the latitude information as the location information by using GPS. Thus, there is no need to have an expensive GPS chip in the sensor itself to obtain the location information, and the number of installing sensors, however large, does not contribute to an increase in cost of the whole system.

The sensor installation location determination support method according to the present disclosure can obtain the identification information of the sensor via the data communication with the sensor using contactless close-range communication.

In the foregoing configuration, the portable terminal communicates with the sensor to obtain the identification information of the sensor via the data communication with the sensor using contactless close-range communication. This enables the server to easily determine which sensor the location information corresponds to. Whether the location for installation is appropriate or not may be determined by comparing with location information of another sensor.

In the sensor installation location determination support method according to the present disclosure, the server can store information regarding the detectable range of each sensor and determines, based on the location information received, whether the installation location is appropriate or not by comparing the location information of a sensor that is already installed and the location information of a sensor to be newly installed.

In the foregoing configuration, whether the installation location is appropriate or not is determined by comparing the location information of a sensor that is already installed and the location information of a sensor to be newly installed based on the location information indicating the installation location of the sensor. Thus, void space between the sensing areas where sensor detection is not possible may be minimized, and at the same time the number of installing sensors may be limited to the minimum.

The foregoing configuration ensures, at the server, collecting of the location information of the installation locations of the sensor even if the sensor itself does not include a means for obtaining location information such as, for example, an expensive GPS chip and the like. Furthermore, the foregoing configuration allows the portable terminal to be used for checking the determination result as to whether the installation location of the sensor to be newly installed is appropriate or not depending on the relative spatial relationship between the sensors. This enables to change the installation location of the sensor to more appropriate location while checking the determination result, and to support installation work so as to install the sensor at a most appropriate location.

### BRIEF DESCRIPTION OF THE SEVERAL VIEWS OF THE DRAWINGS

FIG. 1 is a block diagram depicting a configuration of a sensor installation location determination support system according to one embodiment of the present disclosure.

FIG. 2 is a block diagram depicting a configuration example of a portable terminal of the sensor installation location determination support system according to one embodiment of the present disclosure.

FIG. 3 is a block diagram depicting a configuration example of a server of the sensor installation location determination support system according to one embodiment of the present disclosure.

FIG. 4 is a functional block diagram depicting the portable terminal and the server of the sensor installation location determination support system according to one embodiment of the present disclosure.

FIG. 5 is an exemplary diagram of data configuration of data stored in a sensor information storage unit of the server of the sensor installation location determination support system according to one embodiment of the present disclosure.

FIGS. 6A-6C are conceptual diagrams of determination in a determination unit of the server of the sensor installation location determination support system according to one embodiment of the present disclosure.

FIGS. 7A-7C are exemplary diagrams of determination result display at the portable terminal of the sensor installation location determination support system according to one embodiment of the present disclosure.

FIG. 8 is a flowchart depicting process steps of a CPU of the portable terminal and a CPU of the server of the sensor installation location determination support system according to one embodiment of the present disclosure.

### DETAILED DESCRIPTION

Hereinafter, an embodiment of the present disclosure will be described in detail with reference to the drawings. In the present embodiment, an example is described in which a smartphone is used as a portable terminal.

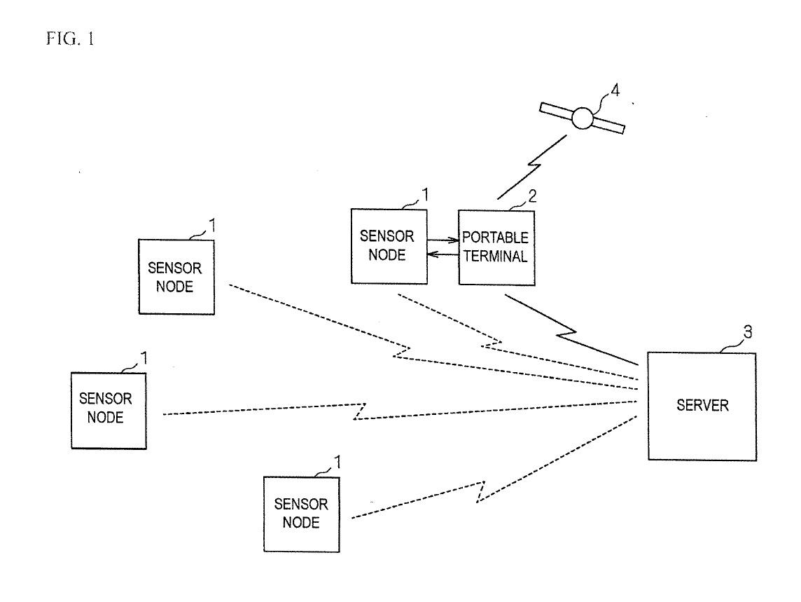

FIG. 1 is a block diagram depicting a configuration of a sensor installation location determination support system according to one embodiment of the present disclosure. As depicted in FIG. 1, the sensor installation location determination support system according to the present embodiment sequentially installs a plurality of sensor nodes 1 that detect characteristic information of target object. Upon bringing a portable terminal 2 close to the sensor node 1, the portable terminal 2 receives characteristic information of target object detected by the sensor node 1 while making a connection with identification information identifying the sensor node 1 via a contactless close-range communication such as, for example, a near field communication (NFC: close-range wireless communication) with the sensor node 1.

The portable terminal 2 that received the characteristic information of target object is equipped with a GPS that communicates with a satellite 4. This allows acquisition of longitude information and latitude information of the portable terminal 2 as location information.

The portable terminal 2 is coupled with the server 3 so as to enable data communication between the portable terminal 2 and the server 3. The portable terminal 2 transmits to the server 3 the identification information and the characteristic information of the sensor node 1 as well as the location information of the portable terminal 2. The transmission to the server 3 can be carried out at the time when the portable terminal 2 obtains the characteristic information and the identification information via the contactless close-range communication with each sensor node 1.

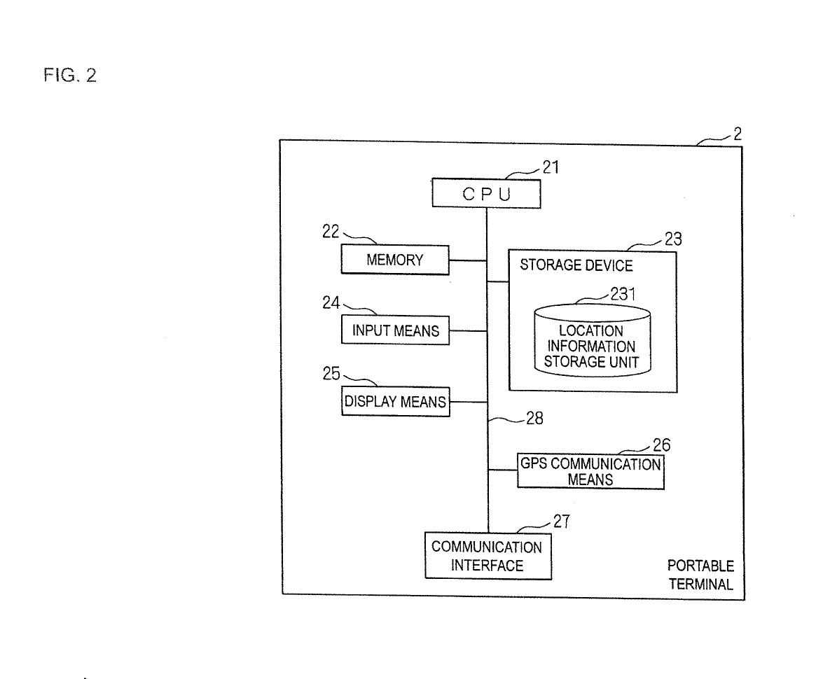

FIG. 2 is a block diagram depicting a configuration example of the portable terminal 2 of the sensor installation location determination support system according to one embodiment of the present disclosure. The portable terminal 2 according to one embodiment of the present disclosure is comprised of, at least, a central processing unit (CPU) 21, a memory 22, a storage device 23, an input means 24, a display means 25, a GPS communication means 26, a communication interface 27, and an internal bus 28 that connects the foregoing hardware.

The CPU 21 is connected to respective units of the foregoing hardware of the portable terminal 2 via the internal bus 28, controls operations of the respective units of the foregoing hardware, and implements various software functionalities in accordance with a computer program stored in the storage device 23. The memory 22 is comprised of volatile memories such as a SRAM, a SDRAM, and the like. In the memory 22, a load module is loaded at the time of executing a computer program, and data and the like that are temporary generated during the execution of the computer program are stored therein.

The storage device 23 is comprised of a built-in fixed type storage device (hard disk), a volatile memory such as a SRAM and the like, a non-volatile memory such as a ROM and the like, and any other similar device. The computer program stored in the storage device 23 is downloaded as information such as a program, data, and the like via the communication interface 27, and then loaded in the memory 22 from the storage device 23 at the time of execution.

Furthermore, the storage device 23 includes a location information storage unit 231 that stores the location information in connection with the identification information obtained from each sensor node 1. The location information storage unit 231 stores, as the location information of the sensor node 1, the location information of the portable terminal 2 at the time when the identification information of the sensor node 1 is obtained via data communication with the sensor node 1 using the contactless close-range communication. The location information is stored in connection with the identification information.

The GPS communication means 26 is connected to the internal bus 28 and is capable of calculating the location information (coordinate location) of the portable terminal 2 and expressing the calculated location information in the longitude information and the latitude information by receiving radio waves transmitted from a plurality of satellites 4 orbiting around the earth with an antenna included in the GPS communication means 26. The calculation of the coordinate location can be carried out at the time when the portable terminal 2 communicates with the sensor node 1 via the contactless close-range communication. Since no continuous GPS communication is needed, the operation process load at the CPU 21 can be reduced.

The communication interface 27 is connected to the internal bus 28 and capable of transmitting and receiving data with the server 3 by connecting to an external network such as the internet, a LAN, a WAN, and the like.

The input means 24 is a data input device such as a touch display, button keys, and the like, and receives input of data. The display means 25 is a display device such as a LCD and the like, which is integrated with the touch display, and displays images needed for operations.

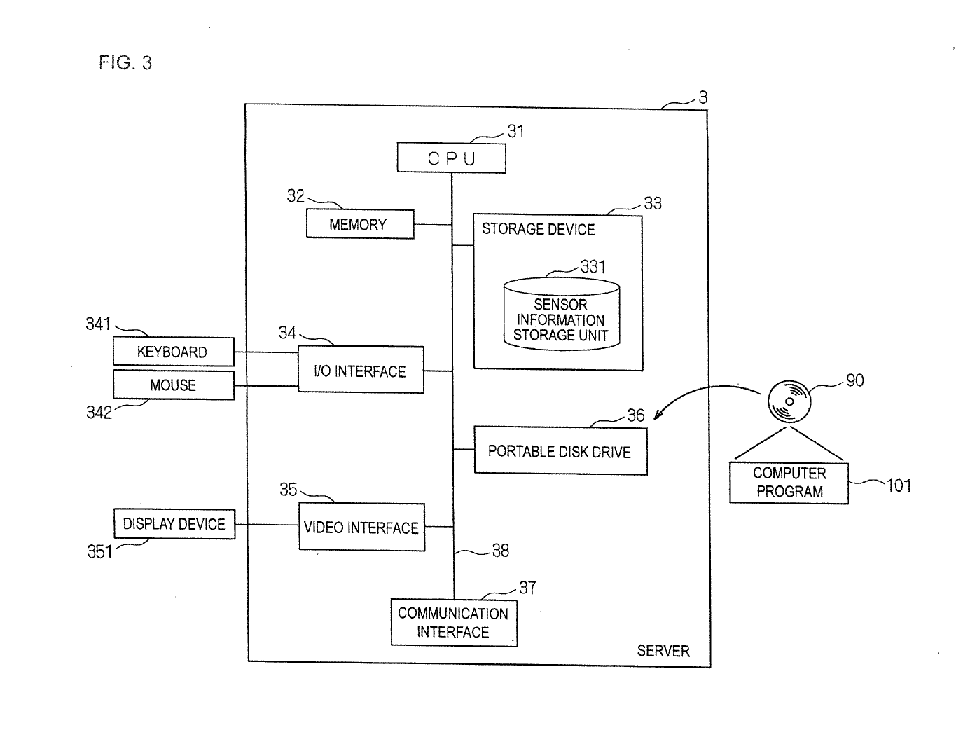

FIG. 3 is a block diagram depicting a configuration example of the server 3 of the sensor installation location determination support system according to one embodiment of the present disclosure. The server 3 according to one embodiment of the present disclosure is comprised of, at least, a central processing unit (CPU) 31, a memory 32, a storage device 33, an I/O interface 34, a video interface 35, a portable disk drive 36, a communication interface 37, and an internal bus 38 that connects the foregoing hardware.

The CPU 31 is connected to respective units of the foregoing hardware of the server 3 via the internal bus 38, controls operations of the respective units of the foregoing hardware, and implements various software functionalities in accordance with a computer program 101 stored in the storage device 33. The memory 32 is comprised of a volatile memory such as a SRAM, SDRAM, and the like. In the memory 32, a load module is loaded at the time of executing the computer program 101, and data and the like that are temporary generated during the execution of the computer program 101 are stored therein.

The storage device 33 is comprised of a built-in fixed type storage device (hard disk), a volatile memory such as a SRAM and the like, a non-volatile memory such as a ROM and the like, and any other similar device. The computer program 101 stored in the storage device 33 is downloaded by the portable disk drive 36 from a portable storage medium 90 such as a DVD, a CD-ROM, and the like, which stores information such as a program and data. At the time of execution, the computer program 101 is loaded from the storage device 33 to the memory 32 for execution. Alternatively, the computer program 101 may be a computer program downloaded from an external computer connected to a network via the communication interface 37.

Furthermore, the storage device 33 includes a sensor information storage unit 331. The sensor information storage unit 331 stores the location information at which each sensor node 1 is installed and information regarding detection conditions, in connection with the identification information identifying the sensor node 1 whose installation has been completed. The detection conditions include a detectable range that is a range within which each sensor node 1 can detect the characteristic information of target object, and the like.

The communication interface 37 is connected to the internal bus 38 and capable of transmitting and receiving data to and from the plurality of the sensor nodes 1 and the portable terminal 2 by connecting to an external network such as the internet, a LAN, a WAN, and the like. The communication interface 37 receives, from the portable terminal 2, the identification information and the location information of the sensor node 1, and transmits, to the portable terminal 2, a determination result as to whether an installation location of the sensor node 1 to be newly installed is appropriate or not. Furthermore, the communication interface 37 receives, from the sensor node 1, the characteristic information detected and the identification information.

The I/O interface 34 is connected to a data input medium such as a keyboard 341, a mouse 342, and the like, and receives input of data. The video interface 35 is connected to a display device 351 such as a CRT monitor, an LCD and the like, for displaying predetermined images.

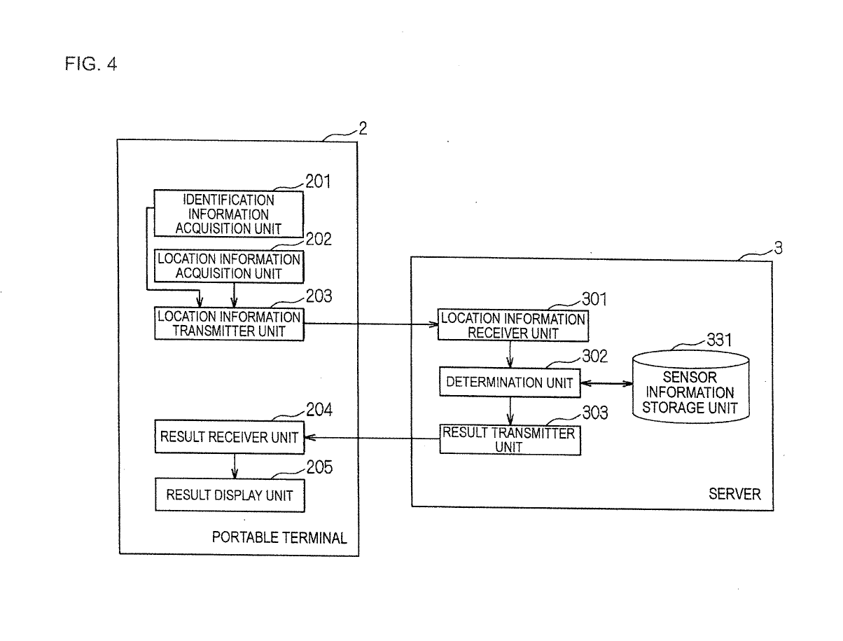

FIG. 4 is a functional block diagram depicting the portable terminal 2 and the server 3 of the sensor installation location determination support system according to one embodiment of the present disclosure. An identification information acquisition unit 201 of the portable terminal 2 communicates with the sensor node 1 via the contactless close-range communication by bringing the portable terminal 2 close to the sensor node 1, and obtains the identification information identifying the sensor node 1.

A location information acquisition unit 202 of the portable terminal 2 receives radio waves from a plurality of satellites 4 via the GPS communication means 26 and obtains the longitude information and the latitude information as the location information. In a case where the portable terminal 2 is a smartphone, assisted GPS (AGPS) may be used. By combining cellular phone's communication network, the assisted GPS enables to improve the accuracy of location information and reduce the time to determine a location. Furthermore, by utilizing a signal from a base station, the location information can be obtained even indoors.

A location information transmitter unit 203 of the portable terminal 2 transmits to the server 3 the obtained location information while making a connection with the identification information identifying the sensor node 1. A location information receiver unit 301 of the server 3 receives the location information and the identification information from the portable terminal 2.

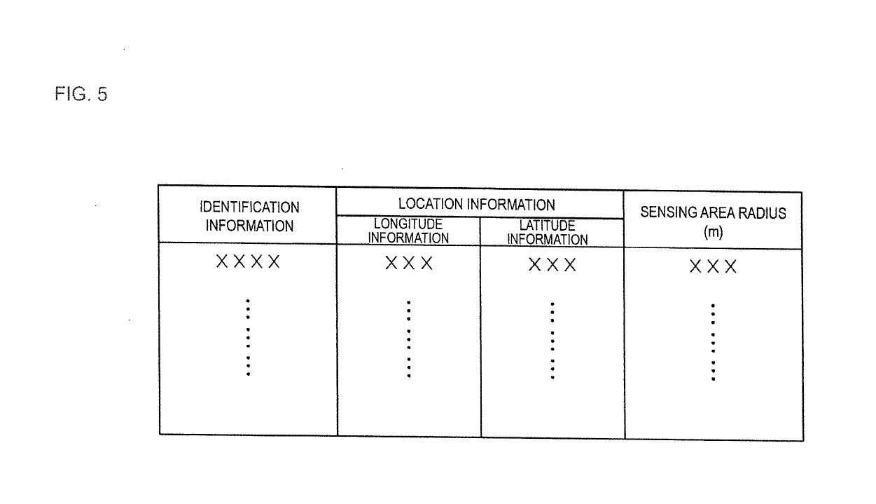

A determination unit 302 of the server 3 determines whether an installation location of the sensor node 1 to be newly installed is appropriate or not based on the received location information. Information of the sensor nodes 1 that are already installed is stored in the sensor information storage unit 331 of the server 3. FIG. 5 is an exemplary diagram of data configuration of data stored in the sensor information storage unit 331 of the server 3 of the sensor installation location determination support system according to one embodiment of the present disclosure.

As depicted in FIG. 5, the sensor information storage unit 331 stores the identification information and the location information (longitude information and latitude information) of the installed sensor nodes 1 as well as information regarding a range within which the sensor node 1 is operational as a sensor, namely, a detectable range (hereinafter, referred to as “sensing area”) that is a range within which the characteristic information of target object can be detected. In the example of FIG. 5, it is assumed that the sensing area is a circular area, and the radius thereof is stored. Obviously, the present embodiment is not limited thereto, and there may alternatively be stored a plurality of plotted points expressed in the center angle θ and the limit distance r with the sensor node 1 being positioned at the center (r-θ coordinate system).

Referring back to FIG. 4, the determination unit 302 determines whether the ratio of an overlapping area to the sensing area falls within a predetermined ratio range or not. The overlapping area is an area where the sensing area of the sensor node 1 that is already installed overlaps with the sensing area of the sensor node 1 to be newly installed. For example, the determination unit 302 determines whether the ratio of the overlapping area to the entire sensing area falls between 5% and 10% inclusive or not. In a case where the ratio of the overlapping area is less than 5%, the installation location of the sensor node 1 is determined as inappropriate because the sensing areas are not sufficiently overlapped and a range in which the characteristic information cannot be detected is too large. In a case where the ratio of the overlapping area is larger than 10%, the installation area of the sensor node 1 is determined as inappropriate because excessive overlapping of the sensing areas may cause an increase in the total number of the sensor nodes 1 to be installed, and thus lead to higher cost.

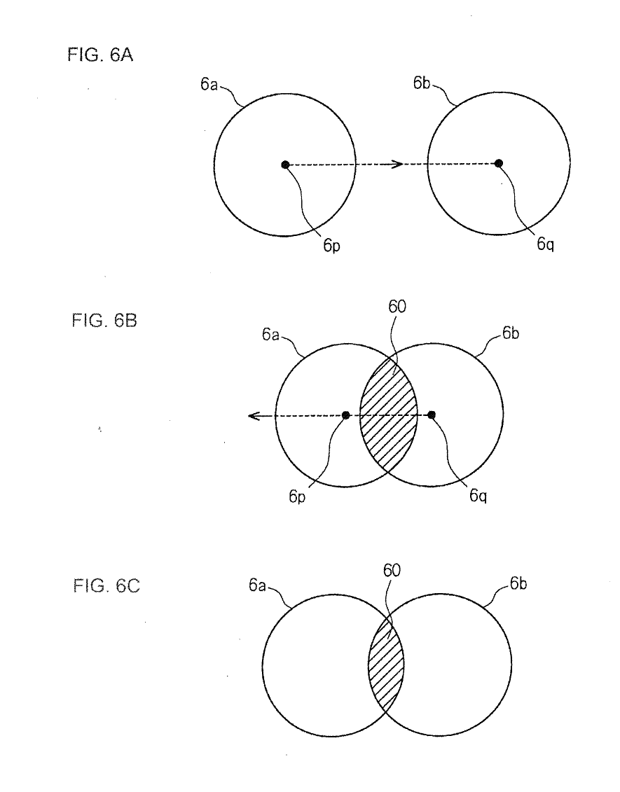

FIGS. 6A-6C are conceptual diagrams of determination in the determination unit 302 of the server 3 of the sensor installation location determination support system according to one embodiment of the present disclosure. As depicted in FIG. 6A, in a case where a sensing area 6a of the sensor node 1 to be newly installed does not overlap with a sensing area 6b of the sensor node 1 that is already installed, the determination unit 302 transmits, to the portable terminal 2, information (appropriateness information) indicating that the installation location of the sensor node 1 is inappropriate as a determination result.

Upon receiving the determination result with the portable terminal 2, a user changes the installation location of the sensor node 1 and repeats a similar process by trial and error until information (appropriateness information) indicating that the installation location of the sensor node 1 is appropriate is received as the determination result. To increase efficiency even in small amount, the determination result can include bearing information indicating which direction the sensor node 1 needs to be moved.

For example, in FIG. 6A, location information 6p of the sensor node 1 to be newly installed and location information 6q of the sensor node 1 that is already installed are obtained. This illustrate that the sensor node 1 needs to be moved in an arrow direction along a straight line connecting the location information 6p and the location information 6q. The server 3 calculates bearing information along which the sensor node 1 is to be moved and transmits the calculated bearing information together with the determination result to the portable terminal 2. This allows the user who received the determination result with the portable terminal 2 to move the sensor node 1 to an appropriate location in a shorter period of time by following the received bearing information.

Furthermore, as depicted in FIG. 6B, in a case where the sensing area 6a of the sensor node 1 to be newly installed largely overlap with the sensing area 6b of the sensor node 1 that is already installed or, for example, in a case where the ratio of an overlapping area 60 to the sensing area 6a or 6b largely exceeds 10%, the sensor nodes 1 can be installed so as to have a little more distance in between. Accordingly, the determination unit 302 transmits, to the portable terminal 2, information (appropriateness information) indicating that the installation location of the sensor node 1 is inappropriate as the determination result.

Upon receiving the determination result with the portable terminal 2, a user changes the installation location of the sensor node 1 and repeats a similar process by trial and error until the information (appropriateness information) indicating that the installation location is appropriate is received as the determination result. However, if the determination result includes the bearing information indicating which direction the sensor node 1 needs to be moved, the sensor node 1 may be moved more efficiently.

For example, in FIG. 6B, the location information 6p of the sensor node 1 to be newly installed and the location information 6q of the sensor node 1 that is already installed are obtained. This illustrates that the sensor node 1 needs to be moved away from each other in an arrow direction along a straight line connecting the location information 6p and the location information 6q. The server 3 calculates bearing information along which the sensor node 1 is to be moved and transmits the calculated bearing information together with the determination result to the portable terminal 2. This allows the user who received the determination result with the portable terminal 2 to move the sensor node 1 to an appropriate location in a shorter period of time by following the received bearing information.

Still furthermore, as depicted in FIG. 6C, in a case where the ratio of the overlapping area 60 to the sensing area 6a or 6b falls between 5% and 10% inclusive, the determination unit 302 transmits, to the portable terminal 2, information (appropriateness information) indicating that the installation location of the sensor node 1 is appropriate as the determination result. Furthermore, at the same time, the identification information and location information of the sensor node 1 are stored at the sensor information storage unit 331.

Referring back to FIG. 4, a result transmitter unit 303 transmits the determination result obtained from the determination unit 302 to the portable terminal 2. It goes without saying that the determination information to be transmitted may include the bearing information described above.

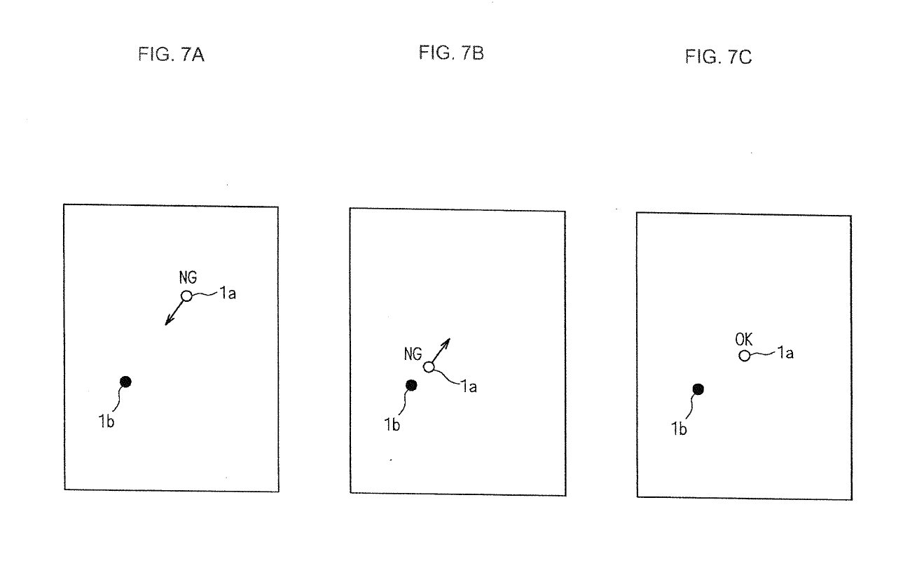

A result receiver unit 204 of the portable terminal 2 receives the determination result from the server 3. A result display unit 205 displays the received determination result on the display means 25 together with, for example, map information. FIGS. 7A-7C are exemplary diagrams of determination result display at the portable terminal 2 of the sensor installation location determination support system according to one embodiment of the present disclosure.

In FIGS. 7A-7C, a black circle symbol represents the sensor node 1b that is already installed, and a white circle symbol represents the sensor node 1a to be newly installed. In the example of FIG. 7A, the distance between the sensor node 1a to be newly installed and the sensor node 1b that is already installed is too large, and thus word “NG” is displayed to indicate the installation location is inappropriate. In this case, the sensing area of the sensor node 1b to be newly installed does not overlap with the sensing area of the sensor node 1a that is already installed. Thus, it is needed to bring the sensor node 1a to be newly installed closer to the sensor node 1b.

To cope with the above, in FIG. 7A, the direction along which the sensor node 1a is to be brought closer is indicated with an arrow. The displayed arrow direction is based on vector information calculated based on the sensor node's location information. The absolute direction of a direction for actual movement is displayed by concurrently using a gyroscope in the portable terminal 2. This allows a user to move the sensor node 1a while the user is watching the screen display.

Furthermore, in the example of FIG. 7B, the distance between the sensor node 1a to be newly installed and the sensor node 1b that is already installed is too small, and thus word “NG” is displayed to indicate the installation location is inappropriate. In this case, the ratio of the overlapping area between the sensing area of the sensor node 1b to be newly installed and the sensing area of the sensor node 1a that is already installed is equal to or larger than a predetermined ratio, for example, larger than 10%. Thus, it is needed to move the sensor node 1a to be newly installed away from the sensor node 1b.

To cope with the above, in FIG. 7B, the direction along which the sensor node 1a is to be moved away is indicated with an arrow. The displayed direction of the arrow is based on vector information calculated from the sensor node's location information. The absolute direction of a direction for actual movement is displayed by concurrently using the gyroscope in the portable terminal 2. This allows a user to move the sensor node 1a while watching the screen display.

In the example of FIG. 7C, word “OK” is displayed to indicate that the distance between the sensor node 1a to be newly installed and the sensor node 1b that is already installed is appropriate. In this case, the ratio of the overlapping area between the sensing area of the sensor node 1b to be newly installed and the sensing area of the sensor node 1a that is already installed is appropriate, and the installation location of the sensor node 1a to be newly installed is appropriate.

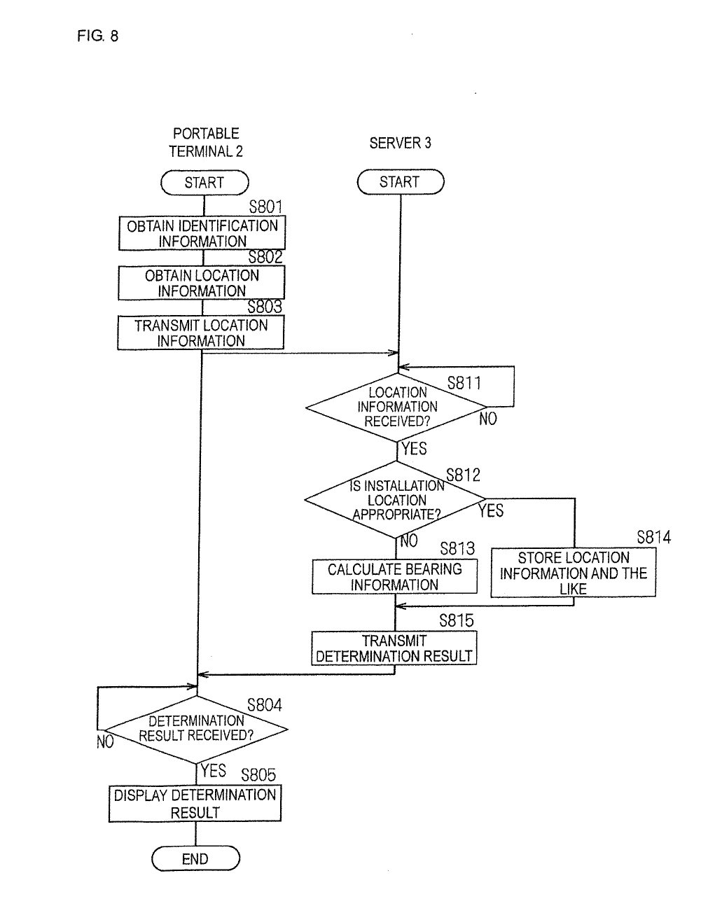

FIG. 8 is a flowchart depicting process steps of the CPU 21 of the portable terminal 2 and the CPU 31 of the server 3 of the sensor installation location determination support system according to one embodiment of the present disclosure. The CPU 21 of the portable terminal 2 communicates with the sensor node 1 via the contactless close-range communication by bringing the portable terminal 2 close to the sensor node 1, and obtains the identification information that identifies the sensor node 1 (step S801).

The CPU 21 receives radio waves from a plurality of satellites 4 via the GPS communication means 26 and obtains longitude information and latitude information as location information (step S802). In the case that the portable terminal 2 is a smartphone, the accuracy of location information may be improved by using Assist GPS (AGPS).

The CPU 21 transmits to the server 3 the obtained location information while making a connection with the identification information identifying the sensor node 1 (step S803).

The CPU31 of the server 3 determines whether or not the location information is received from the portable terminal 2 (step S811). If the CPU 31 determines that the location information is not received yet (step S811: NO), the CPU 31 sets its status to a reception waiting mode. If the CPU 31 determines that the location information is received (step S811: YES), the CPU 31 refers to the sensor information storage unit 331 at which identification information and location information of the sensor nodes 1 that are already installed are stored, and determines whether the installation location is appropriate or not (step S812).

The sensor information storage unit 331 stores the identification information and the location information (longitude information and latitude information) of the sensor nodes 1 that are already installed as well as information regarding a range of each sensor node 1 that is already installed, within which the sensor node 1 is operational as a sensor, namely, a detectable range (hereinafter, referred to as “sensing area”) that is a range within which the characteristic information of target object can be detected. In other words, the location of the portable terminal 2 is taken as the location of the sensor node 1 to be newly installed, and it is determined whether or not the installation location is appropriate while considering matters such as whether or not there is any void space between the sensing areas where detection is not possible, whether or not the number of the sensor nodes 1 installed becomes too large due to large overlapping between the sensing areas, and the like.

More specifically, the CPU 31 determines whether the ratio of the overlapping area to the sensing area falls in a predetermined range or not, the overlapping area being an area where the sensing area of the sensor node 1 that is already installed overlaps with the sensing area of the sensor node 1 to be newly installed. For example, the CPU 31 determines whether the ratio of the overlapping area to the entire sensing area falls between 5% and 10% inclusive or not. In the case where the ratio of the overlapping area is less than 5%, the installation location of the sensor node 1 is determined as inappropriate because the sensing areas are not overlapped and the range in which the characteristic information cannot be detected is too large. In the case where the ratio of the overlapping area is larger than 10%, the installation location of the sensor node 1 is determined as inappropriate because excessive overlapping of the sensing areas may cause an increase in the total number of the sensor nodes 1 to be installed, and thus lead to higher cost.

If the CPU 31 determines that the installation location is inappropriate (step S812: NO), the CPU 31 calculates bearing information that is information regarding the direction along which the sensor node 1 is to be moved (step S813). If the CPU 31 determines that the installation location is appropriate (step S812: YES), the CPU 31 stores the location information and the like in the sensor information storage unit 331 (step S814).

The CPU 31 transmits the determination result including the bearing information to the portable terminal 2 (step S815). The CPU21 of the portable terminal 2 determines whether or not the determination result is received (step S804).

If the CPU 21 determines that the determination result is not received yet (step S804: NO), the CPU 21 sets its status to a reception waiting mode. If the CPU 21 determines that the determination result is received (step S804: YES), the CPU 21 displays the received determination result (step S805). This allows the user to move the sensor node 1 to the most appropriate location while checking the appropriateness of each installation location of the sensor node 1.

As described above, the present embodiment ensures, at the server 3, collection of the location information of the installation locations of the sensor nodes 1 even if the sensor node 1 itself does not include any means for obtaining location information such as, for example, a GPS communication device and the like. Furthermore, the present embodiment allows the portable terminal 2 to be used for checking the determination result as to whether the installation location of the sensor node 1 to be newly installed is appropriate or not depending on the relative spatial relationship between the sensor nodes 1. This enables to change the installation location of the sensor node 1 to more appropriate location while checking the determination result, and to support installation work so as to install the sensor node 1 at the most appropriate location.

Furthermore, it goes without saying the foregoing embodiment may be modified within the scope of the present disclosure. For example, the data communication between the portable terminal 2 and the sensor node 1 is not limited to the data communication via NFC. Any data communication means may be employed as long as such data communication is enabled between the portable terminal 2 and the sensor node 1 when they are brought so close to each other that the location of the portable terminal 2 can be viewed as the location of the sensor node 1.

Furthermore, it is expected that the present disclosure is more advantageous as the number of installing sensors in the system increases. The system may be, for example, a system installing infrared sensors for detecting small animals entering a firm land covering a vast area, a system installing sensors for detecting radiation distribution in an affected area of disaster, a system installing sensors for detecting temperature distribution in the ocean, and the like.

### REFERENCE SIGNS LIST

1 Sensor node (sensor)

2 Portable terminal

3 Server

4 Satellite

21, 31 CPU

22, 32 Memory

23, 33 Storage device

GPS communication means

1. A sensor installation location determination support system including an installed sensor, a sensor to be installed, a portable terminal communicatively coupled with the installed sensor for data communication, and a server collecting information, wherein
the portable terminal includes:
a location information acquisition unit that obtains location information regarding a location of the portable terminal, and
a location information transmitter unit that transmits the location information to the server while relating the location information with identification information identifying the installed sensor, and
the server includes:
a location information receiver that receives the location information and the identification information from the portable terminal,
a determination unit of a central processing unit (CPU) that determines whether an installation location of the sensor to be installed is appropriate based on the location information received, and
a result transmitter transmitting a determination result obtained from the determination unit to the portable terminal.

2. The sensor installation location determination support system according to claim 1, wherein
the location information acquisition unit obtains longitude information and latitude information as the location information by using a global positioning system (GPS).

3. The sensor installation location determination support system according to claim 1, wherein
the location information transmitter unit obtains the identification information of the installed sensor via the data communication with the installed sensor using contactless close-range communication.

4. The sensor installation location determination support system according to claim 1, wherein
the server stores information regarding a detectable range of each of a plurality of installed sensors including the installed sensor, and
the determination unit determines, based on the location information received, whether the installation location is appropriate by comparing location information of the installed sensor and location information of the sensor to be installed.

5. The sensor installation location determination support system according to claim 1, wherein the determination unit determines whether the installation location is appropriate by comparing a ratio of an overlapping area of the installed sensor and the sensor to be installed to a total sensing area of the installed sensor and the sensor to be installed, if the sensor to be installed is installed at the installation location.

6. The sensor installation location determination support system according to claim 5, wherein the installation location is determined to be appropriate if the ratio is between 5% and 10%, inclusive.

7. The sensor installation location determination support system according to claim 1, wherein if the installation location is determined to not be appropriate, the determination unit further determines bearing information indicating a direction in which moving the installation location would result in the installation location being determined to be appropriate.

8. The sensor installation location determination support system according to claim 7, wherein the result transmitter further transmits the bearing information to the portable terminal.

9. A sensor installation location determination support method that can be implemented in a sensor installation location determination support system including an installed sensor, a sensor to be installed, a portable terminal communicatively coupled with the installed sensor for data communication, and a server collecting information, wherein
the portable terminal:
obtains location information regarding a location of the portable terminal, and
transmits the location information to the server while relating the location information with identification information identifying the installed sensor, and
the server:
receives the location information and the identification information from the portable terminal,
determines whether an installation location of the sensor to be installed is appropriate based on the location information received, and
transmits a determination result to the portable terminal.

10. The sensor installation location determination support method according to claim 9, wherein
longitude information and latitude information are obtained as the location information by using a global positioning system (GPS).

11. The sensor installation location determination support method according to claim 9, wherein
the identification information of the installed sensor is obtained via the data communication with the installed sensor using contactless close-range communication.

12. The sensor installation location determination support method according to claim 9, wherein
the server stores information regarding a detectable range of each of a plurality of installed sensors including the installed sensor, and
whether the installation location is appropriate is determined based on the location information received by comparing location information of the installed sensor and location information of the sensor to be installed.

13. The sensor installation location determination support method according to claim 9, wherein the determination unit determines whether the installation location is appropriate by comparing a ratio of an overlapping area of the installed sensor and the sensor to be installed to a total sensing area of the installed sensor and the sensor to be installed, if the sensor to be installed is installed at the installation location.

14. The sensor installation location determination support method according to claim 14, wherein the installation location is determined to be appropriate if the ratio is between 5% and 10%, inclusive.

15. The sensor installation location determination support method according to claim 9, wherein if the installation location is determined to not be appropriate, the determination unit further determines bearing information indicating a direction in which moving the installation location would result in the installation location being determined to be appropriate.

16. The sensor installation location determination support method according to claim 15, wherein the result transmitter further transmits the bearing information to the portable terminal.
